(19) United States
(12) Patent Application Publication
(10) Pub. No.: US 2025/0289050 A1
(43) Pub. Date: Sep. 18, 2025

(54) METAL FORMING PROCESS FOR AUTOMOTIVE PANELS

(71) Applicant: Tesla, Inc., Austin, CA (US)

(72) Inventors: Benjamin Rush, Austin, TX (US); Yogesh Kumar, Austin, TX (US); Yizhou Liu, Austin, TX (US); Asjad Imran Mohammad, Hayward, CA (US); Dipali Karande, Austin, TX (US); Pratik Mehta, Austin, TX (US)

(21) Appl. No.: 19/080,285

(22) Filed: Mar. 14, 2025

Related U.S. Application Data
(60) Provisional application No. 63/566,113, filed on Mar. 15, 2024.

(51) Int. Cl. B21D 53/88; B23K 26/21; B23K 26/38; B23K 101/00; B23K 103/04

(52) U.S. Cl. CPC B21D 53/88; B23K 26/21; B23K 26/38; B23K 2101/006; B23K 2103/05

(57) ABSTRACT

A process for manufacturing a vehicle panel is disclosed. In some embodiments, the process includes processing a metal coil that is made of stainless steel to form a sheet; processing the sheet to form a processed sheet; and bending the processed sheet to form the vehicle panel.

### CLAIM OF PRIORITY

This patent application claims the benefit of priority, under 35 U.S.C. Section 119 (e), to Benjamin Rush et. Al U.S. Provisional Patent Application Ser. No. 63/566,113, entitled “Metal Forming Process For Automotive Panels,” filed on Mar. 15, 2024 (Attorney Docket No. 6474.068PRV), which is hereby incorporated by reference herein in its entirety.

### TECHNICAL FIELD

The present disclosure relates generally to panels. More particularly, the present disclosure relates to automotive panels.

### BACKGROUND

Automotive panels have been primarily made using aluminum and/or steel. However, there may be a need to make outer panels having superior strength, durability, and/or corrosion-resistant attributes than outer panels made of steel or aluminum.

### SUMMARY

In some aspects, the techniques described herein relate to a process of manufacturing a vehicle panel, the process including: processing a metal coil to form a sheet, the metal coil including a first material; processing the sheet to form a processed sheet; and bending the processed sheet to form the vehicle panel, wherein the first material has a strength attribute higher than a strength attribute of steel or aluminum.

In some aspects, the techniques described herein relate to a process, wherein the first material is stainless steel.

In some aspects, the techniques described herein relate to a process, wherein processing the metal coil to form the sheet includes cutting the metal coil using laser blanking.

In some aspects, the techniques described herein relate to a process, wherein processing the sheet to form the processed sheet includes rounding an edge of the sheet using robotic edge rounding.

In some aspects, the techniques described herein relate to a process, wherein bending the processed sheet uses robotic press brake.

In some aspects, the techniques described herein relate to a process, wherein the process does not include hemming the sheet.

In some aspects, the techniques described herein relate to a process, wherein the vehicle panel is a closure outer panel, the process further including joining the closure outer panel with a closure inner panel using laser welding and/or adhesion.

In some aspects, the techniques described herein relate to a process, wherein the vehicle panel is one of a hood, a fender, a door, a sail, a front fascia, a cantrail applique, and a tailgate.

In some aspects, the techniques described herein relate to a vehicle panel assembly, including: a closure outer panel made of stainless steel; and a closure inner panel joined to the closure outer panel, wherein the closure inner panel is joined to the closure outer panel using at least laser welding.

In some aspects, the techniques described herein relate to a vehicle panel assembly, wherein the closure inner panel is made of stainless steel.

In some aspects, the techniques described herein relate to all embodiments described and discussed above.

### BRIEF DESCRIPTION OF THE DRAWINGS

Embodiments of the present disclosure are described with reference to the accompanying drawings, in which like reference characters reference like elements, and wherein:

FIG. 1A illustrates an example method of manufacturing vehicle panels according to some embodiments of the present disclosure.

FIG. 1B illustrates various types of defects associated with coils made of stainless steel.

FIG. 1C shows an example perspective view photograph of a coil before processed by a precision leveler according to some embodiments of the present disclosure.

FIG. 1D shows an example perspective view photograph of a coil that has been processed by a precision leveler according to some embodiments of the present disclosure.

FIG. 2A depicts a perspective view of a panel assembly joined by laser welding according to some embodiments of the present disclosure.

FIG. 2B depicts an enlarged, partial view of the panel assembly of FIG. 2A according to some embodiments of the present disclosure.

FIG. 3A depicts a perspective view of a panel assembly joined by hemming.

FIG. 3B depicts an enlarged, partial view of the panel assembly of FIG. 3A.

### DETAILED DESCRIPTION

Although certain preferred embodiments and examples are disclosed below, the inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations, in turn, in a manner that may be helpful in understanding certain embodiments; however, the order of description should not be construed to imply that these operations are order-dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Generally described, one or more aspects of the present disclosure correspond to methods for forming automotive panels having higher strengths and thicknesses. More specifically, rather than using metals such as aluminum and steel, some embodiments of the present disclosure disclose processes (e.g., a process in the sequence of laser blanking, robotic edge rounding, and robotic press brake) that use stainless steel materials to form outer panels of automotives. Advantageously, outer panels formed using disclosed processes can be bullet-proof because of its characteristics of higher strengths and thicknesses. In some embodiments, rather than using hemming techniques that are incapable of processing outer panels having higher strengths and thicknesses, outer panels formed may be further joined with inner panels through a combination of adhesion and laser welding techniques.

In traditional designs, outer panels (e.g., hoods, fenders, doors, sail, tailgate, or the like) for vehicles have predominantly been crafted using steel or aluminum materials through processes that include blanking, metal stamping, and then hemming that for example employ stamping dies that can draw, trim, pierce, flange or otherwise process metals. However, there may be a need to make outer panels having superior strength, durability, and/or corrosion-resistant attributes than outer panels made of steel or aluminum. For example, in some applications, outer panels that are bullet proof may be desired.

To form outer panels having superior strength than aluminum or steel, stainless steel materials may be employed. Yet, due to characteristics (e.g., strength, thickness, and ductility) of stainless steel, some manufacturing processes applicable for forming outer panels using aluminum or steel cannot be utilized to form outer panels based on stainless steel. For example, due to the strength and ductility of stainless steel, traditional hemming processes (e.g., folding an edge of an outer panel over an edge of an inner panel) may not be used to join an outer panel (e.g., a closure outer panel) formed using stainless steel with a closure inner panel.

Additionally, due to design tolerance demanded for outer panels in certain applications, it may also be desirable to increase blanking accuracy when making outer panels. In these applications that demand strict design tolerance, blanking techniques that result in around +/−1 millimeter (mm) may be unsatisfying.

To address at least a portion of the above problems, methods for using higher strength materials (e.g., stainless steel) to form panels (e.g., closure outer panels, closure inner panels), and join closure outer panels and closure inner panels are disclosed in accordance with some embodiments of the present disclosure. In some embodiments, a process for forming closure outer panels includes laser blanking (e.g., high speed and high precision laser blanking), robotic edge rounding (e.g., robotic abrasive techniques to round edges of sheet metals), and robotic press brake. In some embodiments, a process for joining a closure outer panel and a closure inner panel includes laser welding and adhesive bonding to advantageously form panel assemblies that can be bullet-proof, durable, and resistant to corrosion.

More specifically, to form a closure outer panel, a coil made of stainless steel may be fed to a laser blanking line. The laser blanking line may employ a precision leveler and an accuracy package to significantly improve blanking accuracy when cutting the coil. In some embodiments, through using the precision leveler and the accuracy package, blanking accuracy may be improved from around +/−1 mm to around or below +/−0.3 mm. As such, a sheet made of stainless steel resulted from the laser blanking step can meet design tolerance demands for certain high-precision applications.

In some embodiments, the sheet can be further processed using robotic edge rounding. For example, robotic edge rounding can round (e.g., smoothen) edges of the sheet made of stainless steel to avoid sharp edges, thereby increasing user safety. As such, techniques of hemming (e.g., joining an inner panel and an outer panel together) that can ensure no sharp edge present in a panel and also achieve smooth radius on outer edges for safety requirement may not be needed. Advantageously, robotic edge rounding is capable of processing sheets made of stainless steel that have higher strength, higher thickness, and lower ductility while making the edge-rounded sheet (e.g., a sheet having smooth edges or a sheet without any sharp edges).

Additionally, the edge-rounded sheet made of stainless steel may be further processed using robotic press brake. In some embodiments, the robotic press brake step may bend and/or mold the edge-rounded sheet into desired shapes by exerting forces on the edge-rounded sheet through robotic machinery to form a bent sheet (e.g., the closure outer panel) made of stainless steel.

Additionally and/or optionally, the closure outer panel made of stainless steel may go through further processing (e.g., post processing) that removes extra material deployed specifically for the robotic press brake and/or further rounds of the bent sheet to structurally match other panel(s). In some embodiments, post processing may include laser trimming and edge rounding. In some embodiments, post processing may not be performed on all vehicle panels. For examples, post processing may be performed on fenders and sails, but not on other vehicle panels such as hood outers or fascia outers.

To join a closure outer panel and a closure inner panel, rather than employing hemming techniques for joining, the closure outer panel and the closure inner panel may be joined by laser welding in some embodiments. Additionally and/or optionally, the closure outer panel and the closure inner panel may also be joined through adhesive (e.g., glue) bonding. Advantageously, the closure outer panel made of stainless steel and the closure inner panel may be effectively joined without hemming to form panel assemblies that are durable and more resistant to corrosion.

In some embodiments, to increase compatibility and achieve solid joining between a closure outer panel and a closure inner panel, the closure inner panel may also be made of stainless steel. In these embodiments, materials used for dies in a metal stamping process for forming the closure inner panel made of stainless steel may be different from other dies used on steel and/or aluminum. More specifically, when processing aluminum and/or steel, materials such as chromium can be contained in dies used for a metal stamping process. Because aluminum and/or steel contain less chromium (e.g., less than 1% in weight percentages), there may be no manufacturing issues when using dies that include chromium. But because stainless steel contains more chromium (e.g., between 16% to 24% in weight percentages), using dies that include chromium for processing stainless steel may result in issues such as galling and cold welding. As such, materials that may be dissimilar to or devoid of chromium may be utilized to make dies used in a metal stamping process for forming the closure inner panel made of stainless steel.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of panels, outer panels, closure panels, panel assemblies and the like. Still further, although a specific process of forming panels based on stainless steel will be described, such illustrative panel forming process or steps should not be construed as limiting. Accordingly, one skilled in the relevant art will appreciate that the aspects of the present application are not necessarily limited to application to any particular type of material, or vehicle panels.

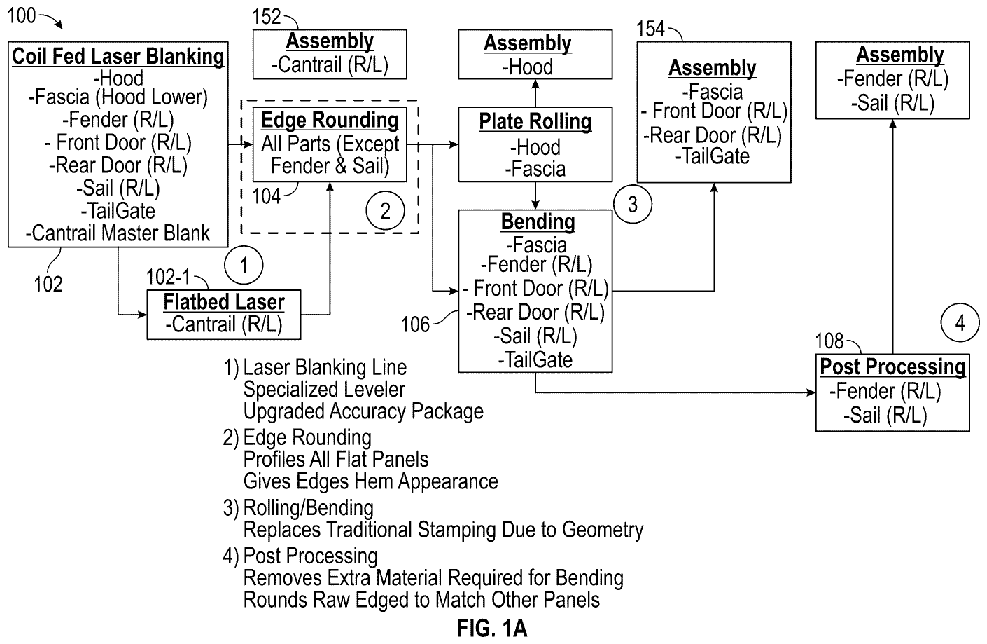

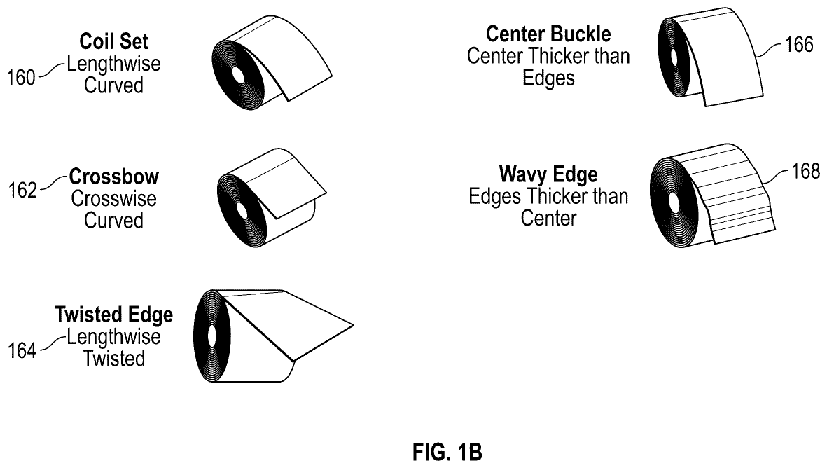

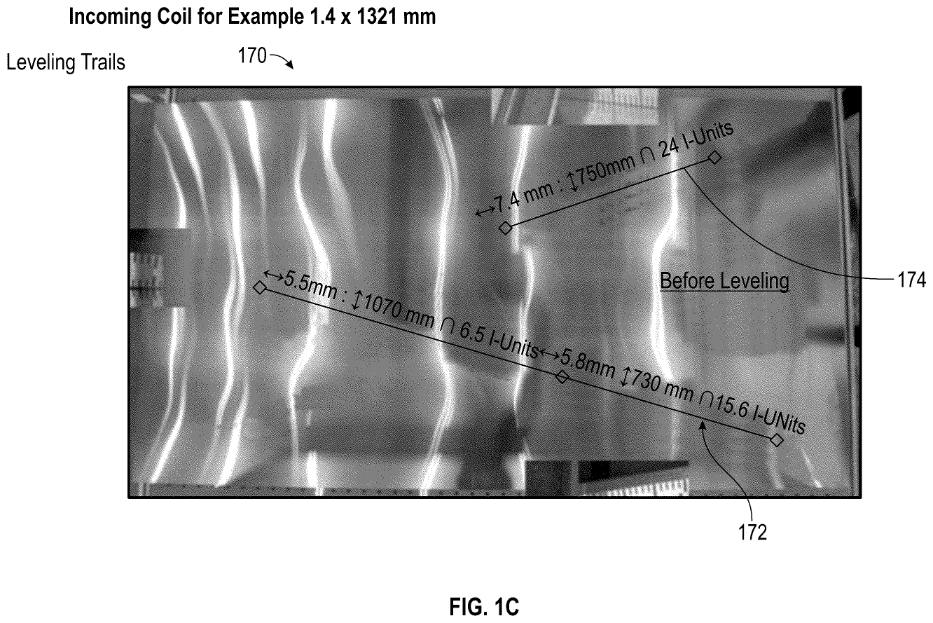

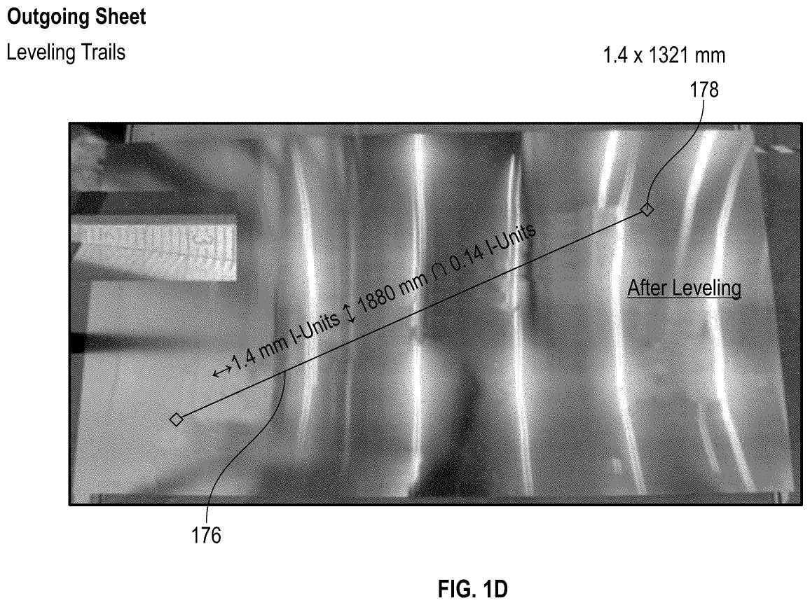

FIG. 1A shows an example method 100 of manufacturing vehicle panels using materials having higher strength than aluminum and/or steel. For example, the method 100 may be used to form outer panels that are made of stainless steel and other types of materials having higher strength than aluminum and/or steel. In some embodiments, the method 100 may include steps or techniques of laser blanking (e.g., high speed and high precision laser blanking), robotic edge rounding (e.g., robotic abrasive techniques to round edges of sheet metals), and robotic press brake.

In some embodiments, at step 102, a coil made of stainless steel may be fed to a laser blanking line. The laser blanking line may employ a precision leveler and an accuracy package to significantly improve blanking accuracy when cutting the coil. In some embodiments, through using the precision leveler and the accuracy package, blanking accuracy may be improved from around +/−1 mm to around or below +/−0.3 mm. As such, a sheet formed at step 102 can meet design tolerance demands for certain high-precision applications.

More specifically, coils made of stainless steel may have various kinds of defects as shown in FIG. 1B. As shown in 160, a coil may be lengthwise curved. As shown in 162, a coil may be crosswise curved. As shown in 164, a coil may be lengthwise twisted. As shown in 166, a coil may have a center that is thicker than edges. As shown in 168, a coil may have edges that are thicker than a center. Using coils having one of the defects for manufacturing panels may result in panels having inferior qualities. As such, it may be desirable to reduce or eliminate defects illustrated in FIG. 1B.

In some embodiments, a precision leveler (e.g., an equipment with a plurality of rolling units to level defective coils) may be employed to process defective coils to form coils that are flat or have less defects illustrated in FIG. 1B. Through the precision leveler, a flatness of a coil can be increased before feeding the coil to a laser blanking line to form sheets that meet design tolerance demands.

FIG. 1C shows an example perspective view photograph of a coil 170 made of stainless steel before being processed by the precision leveler. As shown in FIG. 1C, the coil 170 has a thickness of 1.4 mm and a length of 1321 mm. FIG. 1C illustrates that a first example flatness measured on the coil 170 along the path 172 is 15.6 I-Units, and a second example flatness measured on the coil 170 along the path 174 is 24 I-Units. Other flatness values are possible. The coil 170 may contain waves (or undulations) having one or more varied wave heights and/or wave lengths along a distance of the path 172 and/or the path 174. A given path may include one or more wave distances and/or wave heights. In some examples, a path, such as the path 172, may include a first wave height extending along a first distance in a first portion of the coil 170 (for example, a wave height of 5.5 mm occurring in a path or wave distance of 1070 mm), and a second wave height extending along a second distance in a second portion of the coil 170 (for example, a wave height of 5.8 mm occurring in a path or wave distance of 730 mm). In some examples, the path 174 includes a wave height of 7.4 mm occurring in a path or wave distance of 750 mm. Other values of wave heights, wave distances, and wave paths are possible.

FIG. 1D shows an example perspective view photograph of the coil 170 that has been processed by the precision leveler. This coil is flatter. More specifically, FIG. 1D illustrates that an example flatness measured on the coil 170 after being processed by the leveler along a path 176 is 0.14 I-Units, less than before the coil 170 is processed by the precision leveler. In some examples, a wave extending along the path 176 includes a wave height of 1.4 mm occurring in a path or wave distance of 1880 mm. Other flatness values, wave height values, wave distances and/or path lengths are possible. In some examples, a datum pin 178 is used to measure aspects such as flatness, and/or a wave height, and/or a wave distance or path along the coil 170 after leveling. In some examples, through using the precision leveler, a flatness of the coil 170 is increased before feeding the coil 170 to a laser blanking line to form sheets that meet design tolerance demands.

Referring back to FIG. 1A, optionally, the method 100 may proceed to step 102-1, where a sheet formed at step 102 can be processed using a flatbed laser for certain applications.

At step 104, a sheet may be processed to form a processed sheet using robotic edge rounding. In some embodiments, robotic edge rounding can round edge(s) of the sheet formed at step 102 to form the processed sheet that is edge-rounded (e.g., a sheet having smooth edges or a sheet without any sharp edges).

In some embodiments, robotic edge rounding may be performed at step 104 on vehicle panels such as hood outers, door outers, tailgate outers, cantrail outers, fascia outers, but may not be performed at step 104 on vehicle panels such as fenders and sails.

More specifically, the processed sheet that is edge-rounded or without any sharp edges may be formed without using hemming to ensure no sharp edges. Advantageously, using robotic edge rounding at step 104 enables the method 100 to process sheets made of stainless steel that have higher strength, higher thickness, and lower ductility while form edge-rounded sheets that may have no sharp edges to increase user operation safety.

In some embodiments, when manufacturing certain types of vehicle panels (e.g., cantrail), the processed sheet formed at step 104 may be assembled at step 152 without further bending.

At step 106, the processed sheet formed at step 104 may be further processed using robotic press brake. More specifically, robotic press brake may bend and/or mold the processed sheet formed at step 104 into desired shapes by exerting forces on the processed sheet that is edge-rounded through robotic machinery to form a vehicle panel, such as a closure outer panel.

In some embodiments, when manufacturing certain types of vehicle panels (e.g., fascia, a front door, a rear door, a tailgate), a bent sheet or a vehicle panel formed at step 106 may be assembled at step 154 without further processing.

In some embodiments, at step 108, a vehicle panel formed at step 106 can go through post processing that may remove extra material deployed specifically for the robotic press brake performed at step 106. Optionally, at step 108, edge(s) of a vehicle panel formed at step 106 may be further rounded to structurally match other panel(s).

In some embodiments, post processing performed at step 108 may include laser trimming and edge rounding. In some embodiments, post processing may be performed on vehicle panels such as fenders and sails. For example, post processing may be applied to remove extra materials from fenders and sails after the fenders and the sails are bent at step 106. After extra materials are removed from fenders and sails, edge rounding may be further applied on the fenders and sails to remove any sharp edges.

Although not illustrated in FIG. 1A, in some embodiments, a closure outer panel formed by the method 100 may be joined with a closure inner panel without hemming. For example, the closure outer panel and the closure inner panel may be joined by laser welding. Additionally and/or optionally, the closure outer panel and the closure inner panel may also be joined through adhesive (e.g., glue) bonding.

It should be noted that vehicle panels manufactured by the method 100 can include hoods (e.g., a hood outer), fenders (e.g., a fender outer), doors (e.g., a front door outer, a rear door outer, or the like), sails (e.g., a sail outer), tailgates (e.g., a tailgate outer), front fascia, cantrail applique, or the like. In some embodiments, a hood outer manufactured by the method 100 may have a thickness of, of about, of at least, or of at least about, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, or any range of values therebetween.

In some embodiments, a front fascia manufactured by the method 100 may have a thickness of, of about, of at least, or of at least about, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, or any range of values therebetween.

In some embodiments, a fender outer manufactured by the method 100 may have a thickness of, of about, of at least, or of at least about, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, or any range of values therebetween.

In some embodiments, a front door outer manufactured by the method 100 may have a thickness of, of about, of at least, or of at least about, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, or any range of values therebetween.

In some embodiments, a rear door outer manufactured by the method 100 may have a thickness of, of about, of at least, or of at least about, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, or any range of values therebetween.

In some embodiments, a sail outer manufactured by the method 100 may have a thickness of, of about, of at least, or of at least about, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, or any range of values therebetween.

In some embodiments, a cantrail applique manufactured by the method 100 may have a thickness of, of about, of at least, or of at least about, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, or any range of values therebetween.

In some embodiments, a tailgate outer manufactured by the method 100 may have a thickness of, of about, of at least, or of at least about, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, or any range of values therebetween.

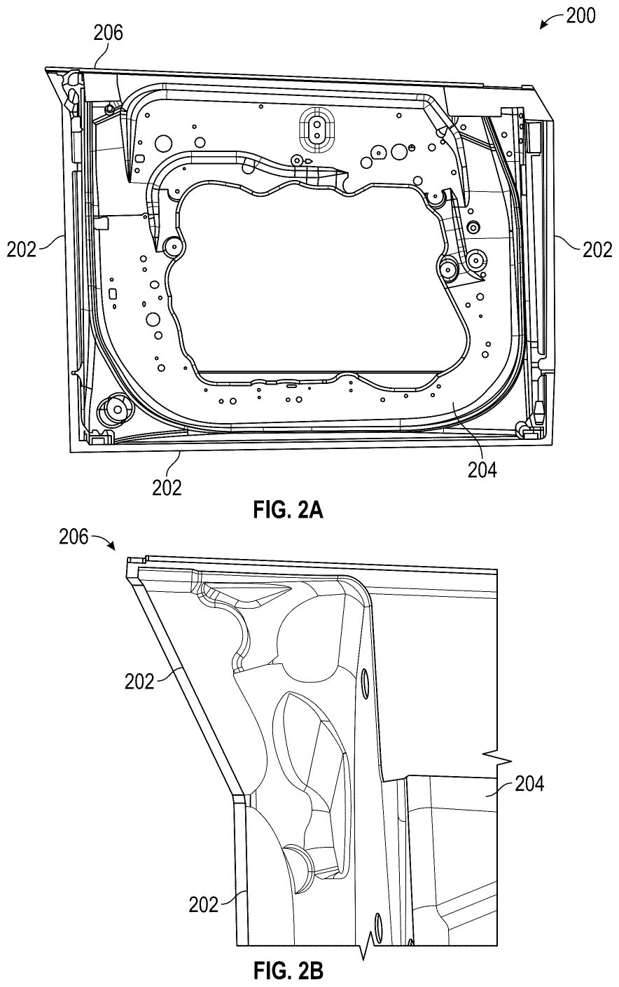

FIG. 2A depicts a perspective view of a panel assembly 200 joined by laser welding according to some embodiments of the present disclosure. The panel assembly 200 includes a closure inner panel 204 and a closure outer panel 206 (mostly blocked by the closure inner panel 204 in FIG. 2A). In some embodiments, the closure outer panel 206 is made of stainless steel and can be formed using the method 100.

FIG. 2A illustrates that the closure outer panel 206 and the closure inner panel 204 are joined together by laser welding to form the panel assembly 200. More specifically, the edge 202 of the panel assembly 200 illustrates that the closure outer panel 206 and the closure inner panel 204 are joined by laser welding. Advantageously, the closure outer panel 206 and the closure inner panel 204 may be effectively joined to form panel assemblies that are durable and more resistant to corrosion without hemming that may be inappropriate for processing (e.g., folding) the closure outer panel 206 made of stainless steel.

FIG. 2B depicts an enlarged, partial view of the panel assembly 200 of FIG. 2A according to some embodiments of the present disclosure. In FIG. 2B, the edge 202 of the panel assembly 200 illustrates more clearly that the closure outer panel 206 and the closure inner panel 204 are joined by laser welding.

In some embodiments, to increase compatibility and achieve solid joining between the closure outer panel 206 and the closure inner panel 204, the closure inner panel 204 may also be made of stainless steel. In these embodiments, materials used for dies in a metal stamping process for forming the closure inner panel 204 made of stainless steel may be different from other dies used on steel and/or aluminum. More specifically, when processing aluminum and/or steel, materials such as chromium can be contained in dies used for a metal stamping process. Because aluminum and/or steel contain less chromium (e.g., less than 1% in weight percentages), there may be no manufacturing issues when using dies that include chromium. But because the closure inner panel 204 made of stainless steel contains more chromium (e.g., between 16% to 24% in weight percentages), using dies that include chromium for processing the closure inner panel 204 may result in issues such as galling and cold welding. As such, materials that may be dissimilar to or devoid of chromium may be utilized to make dies used in a metal stamping process for forming the closure inner panel 204 made of stainless steel.

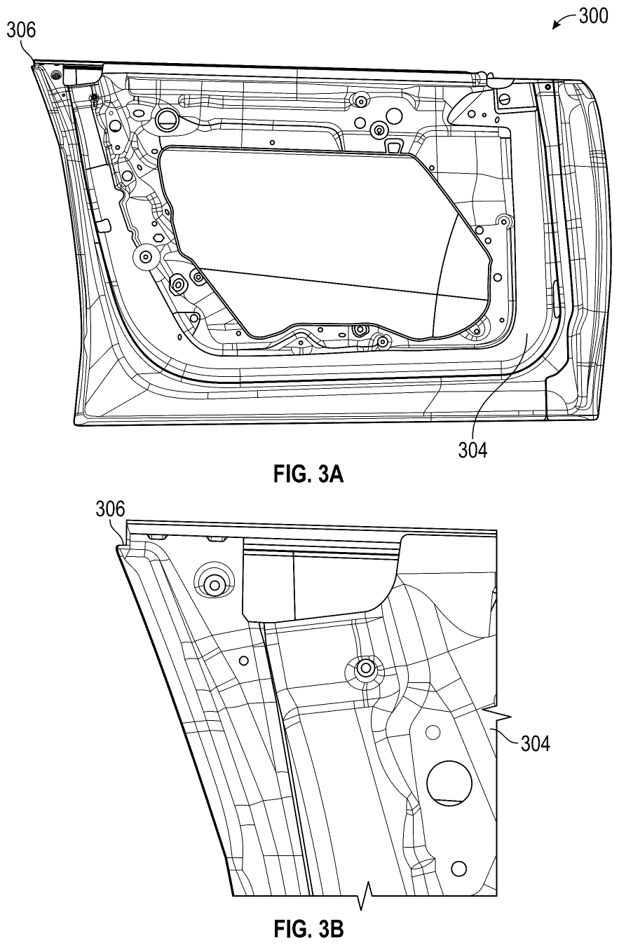

FIG. 3A depicts a perspective view of a panel assembly 300 joined by hemming. FIG. 3A illustrates that a closure outer panel 306 and a closure inner panel 304 are joined together through hemming. The closure outer panel 306 may be made of aluminum or steel.

FIG. 3B depicts an enlarged, partial view of the panel assembly 300 of FIG. 3A. As shown in FIG. 3B and FIG. 2B, the edge 202 of the panel assembly 200 that is joined through laser welding have similar appearance to edges of the panel assembly 300.

### EXAMPLES

Example 1: A process of manufacturing a vehicle panel, the process comprising: processing a metal coil to form a sheet, the metal coil comprising a first material; processing the sheet to form a processed sheet; and bending the processed sheet to form the vehicle panel, wherein the first material has a strength attribute higher than a strength attribute of steel or aluminum.

Example 2: The process of Example 1, wherein the first material is stainless steel.

Example 3: The process of one or more of Example 1-2, wherein processing the metal coil to form the sheet comprises cutting the metal coil using laser blanking.

Example 4: The process of one or more of Example 1-3, wherein further comprises processing the metal coil using a precision leveler.

Example 5: The process of one or more of Example 1-4, wherein processing the sheet to form the processed sheet comprises rounding an edge of the sheet using robotic edge rounding.

Example 6: The process of one or more of Example 1-5, wherein bending the processed sheet uses robotic press brake.

Example 7: The process of one or more of Example 1-6, further comprising processing the vehicle panel after bending to remove extra material deployed for the bending.

Example 8: The process of one or more of Example 1-7, wherein the process is devoid of hemming the sheet.

Example 9: The process of one or more of Example 1-8, wherein the vehicle panel is a closure outer panel, the process further comprising joining the closure outer panel with a closure inner panel using laser welding and/or adhesion.

Example 10: The process of one or more of Example 1-9, wherein the vehicle panel is one of a hood, a fender, a door, a sail, a front fascia, a cantrail applique, and a tailgate.

Example 11: A vehicle panel assembly, comprising a closure outer panel made of stainless steel; and a closure inner panel joined to the closure outer panel, wherein the closure inner panel is joined to the closure outer panel using at least laser welding.

Example 12: The vehicle panel assembly of Example 11, wherein the closure inner panel is made of stainless steel.

Example 13: The vehicle panel assembly of one or more of Example 11-12, further comprising the closure inner panel and the closure outer panel being joined by adhesive bonding.

Example 14: The vehicle panel assembly of one or more of Example 11-13, wherein the closure outer panel includes rounded edges formed by robotic edge rounding.

Example 15: The vehicle panel assembly of one or more of Example 11-14, wherein the closure outer panel is processed using a precision leveler.

Example 16: The vehicle panel assembly of one or more of Example 11-15, further comprising a thickness of the closure outer panel selected based on a type of vehicle panel.

Example 17: The vehicle panel assembly of one or more of Example 16, wherein the type of vehicle panel is one of a hood, a fender, a door, a sail, a front fascia, a cantrail applique, and a tailgate.

Example 18: The vehicle panel assembly of one or more of Example 11-16, wherein the closure outer panel is bullet-proof.

Example 19: The vehicle panel assembly of one or more of Example 11-18, wherein the stainless steel of the closure outer panel is corrosion resistant.

Example 20: The vehicle panel assembly of one or more of Example 11, wherein the closure outer panel comprises rounded edges.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of customer computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable customer computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A process of manufacturing a vehicle panel, the process comprising:
processing a metal coil to form a sheet, the metal coil comprising a first material;
processing the sheet to form a processed sheet; and
bending the processed sheet to form the vehicle panel,
wherein the first material has a strength attribute higher than a strength attribute of steel or aluminum.

2. The process of claim 1, wherein the first material is stainless steel.

3. The process of claim 1, wherein processing the metal coil to form the sheet comprises cutting the metal coil using laser blanking.

4. The process of claim 1, further comprises processing the metal coil using a precision leveler.

5. The process of claim 1, wherein processing the sheet to form the processed sheet comprises rounding an edge of the sheet using robotic edge rounding.

6. The process of claim 1, wherein bending the processed sheet uses robotic press brake.

7. The process of claim 1, further comprising processing the vehicle panel after bending to remove extra material deployed for the bending.

8. The process of claim 1, wherein the process is devoid of hemming the sheet.

9. The process of claim 1, wherein the vehicle panel is a closure outer panel, the process further comprising joining the closure outer panel with a closure inner panel using laser welding and/or adhesion.

10. The process of claim 1, wherein the vehicle panel is one of a hood, a fender, a door, a sail, a front fascia, a cantrail applique, and a tailgate.

11. A vehicle panel assembly, comprising:
a closure outer panel made of stainless steel; and
a closure inner panel joined to the closure outer panel,
wherein the closure inner panel is joined to the closure outer panel using at least laser welding.

12. The vehicle panel assembly of claim 11, wherein the closure inner panel is made of stainless steel.

13. The vehicle panel assembly of claim 11, further comprising the closure inner panel and the closure outer panel are joined by adhesive bonding.

14. The vehicle panel assembly of claim 11, wherein the closure outer panel includes rounded edges formed by robotic edge rounding.

15. The vehicle panel assembly of claim 11, wherein the closure outer panel is processed using a precision leveler.

16. The vehicle panel assembly of claim 11, further comprising a thickness of the closure outer panel selected based on a type of vehicle panel.

17. The vehicle panel assembly of claim 16, wherein the type of vehicle panel is one of a hood, a fender, a door, a sail, a front fascia, a cantrail applique, and a tailgate.

18. The vehicle panel assembly of claim 11, wherein the closure outer panel is bullet-proof.

19. The vehicle panel assembly of claim 11, wherein the stainless steel of the closure outer panel is corrosion resistant.

20. The vehicle panel assembly of claim 11, wherein the closure outer panel comprises rounded edges.
